(19) United States
(12) Patent Application Publication
(10) Pub. No.: US 2010/0112365 A1
(43) Pub. Date: May 6, 2010

(54) LAYERED-STRUCTURE VULCANIZATES BASED ON HYDROGENATED VINYL POLYBUTADIENE

(75) Inventors: Werner Obrecht, Moers (DE); Andreas Bischoff, Dormagen (DE); Alexander Lissy, Leverkusen (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/304,778

(22) PCT Filed: Jun. 25, 2007
(86) PCT No.: PCT/EP2007/005578

§ 371 Date: Jan. 13, 2010

(30) Foreign Application Priority Data
Jul. 1, 2006 (DE) 10 2006 031 317.8

(51) Int. Cl. B32B 25/08; B32B 27/08; C08F 8/34; B29C 47/06

(52) U.S. Cl. 428/519; 428/492; 525/192; 264/211.12

(57) ABSTRACT

The present invention relates to layered-structure vulcanizates, where at least one of the layers is composed of a hydrogenated vinylpolybutadiene and the other layers are preferably composed of rubbers double bonds.

The present invention relates to layered-structure vulcanizates, where at least one of the layers is composed of a hydrogenated vinylpolybutadiene and the other layers are preferably composed of rubbers containing double bonds. The vulcanizates of the invention are produced via co-vulcanization of the structure composed of a plurality of layers, by means of a sulphur-containing vulcanization system.

Many application sectors use a layered structure of the vulcanizates, since first the individual layers composed of different materials have very specific functional requirements to satisfy, and secondly good adhesion of the layers to one another is of decisive importance for the functional capability of the entire structure. Examples of layered-structure vulcanizates are tyres, hoses, drive belts and conveyor belts.

For the production of layered-structure co-vulcanizates it is necessary that the individual layers in the unvulcanized state have sufficiently high tack, and that sufficient adhesion of the layers is present after vulcanization.

This object is achieved, for example, by using mixtures of different rubbers for the production of the individual layers. This procedure in particular achieves the objective if each of two adjacent rubber mixtures comprises a proportion of the same rubber. The result of this is not only good tack of the layers in the unvulcanized state but also good adhesion of the layers after vulcanization. Since the requirements placed upon the layers of a co-vulcanizate are often very different, admixtures of foreign rubbers alter the specific property profile of the vulcanized rubber mixture, and the layered-structure vulcanizate then fails overall to achieve the desired purpose. It can moreover be very costly to determine the ideal amount of foreign rubber, since firstly there is a need to minimize the amount of foreign rubber but secondly a certain minimum amount of the foreign rubber is necessary to achieve sufficient tack in the unvulcanized state, and sufficient adhesion after vulcanization.

If two adjacent rubber layers are totally incompatible, and lack both a minimum level of tack between the layers and a minimum of co-vulcanizability, and moreover the admixture of foreign rubber as described above does not achieve the objective, layered-structure vulcanizates can be produced by applying an intermediate layer. According to the teaching of DE 3836251-A1, epoxidized natural rubber is used as intermediate layer. Using the intermediate layer composed of epoxidized natural rubber, layered-structure vulcanizates can be produced either for polar rubbers, e.g. for a layer vulcanizate composed of polychloroprene and nitrile rubber, or for layer composites composed of polar and non-polar rubbers. Examples of polar rubbers are polychloroprene and nitrile rubbers. Examples of non-polar rubbers are natural rubber, polybutadiene rubber and styrene-butadiene copolymers. However, this procedure is very complicated, since an additional rubber layer has to be produced and applied.

Fully and partially hydrogenated vinylpolybutadienes are known, as also are the uncrosslinked products providing the key properties (DE 10324304 A1). There has hitherto been no description of the use of hydrogenated vinylpolybutadiene for the production of layered-structure vulcanizates, or in particular of a method for establishing sufficiently high tack of the unvulcanized layers and of giving the layers sufficiently high adhesion after vulcanization. Nor does DE 10324304 A1 teach a method of vulcanization.

It is therefore an object of the present invention to provide layered-structure vulcanizates, where at least one of these layers comprises hydrogenated vinylpolybutadiene.

It has now been found that unvulcanized rubber mixtures based on hydrogenated vinylpolybutadiene whose vinyl contents prior to hydrogenation are from 30 to 70% and whose degrees of hydrogenation are from 70 to 98% have sufficient tack without any additions of foreign rubbers, thus permitting production of layered structures which have adequate adhesion between the layers after vulcanization, using a sulphur-based vulcanization system for the co-vulcanization of the various layers.

The present invention therefore provides layered-structure vulcanizates, characterized in that at least one of the layers is composed of a hydrogenated vinylpolybutadiene rubber whose vinyl content prior to hydrogenation is from 30 to 70% and whose degree of hydrogenation is from 70 to 98%, and whose Mooney values are from 40 to 140 Mooney units (ML 1+4/125° C.), and the other layers are composed of rubbers containing double bonds.

The hydrogenated vinylpolybutadienes selected preferably comprise those whose degrees of hydrogenation are from 80 to 95%, whose vinyl contents prior to hydrogenation are from 40 to 60% and whose Mooney values are in the range from 60 to 135 Mooney units.

As a function of their intended purpose, the layered-structure vulcanizates can, of course, comprise any desired number of the layers composed of hydrogenated vinylpolybutadienes. The location of the layers composed of the hydrogenated vinylpolybutadienes can be in the outer region of the layered-structure vulcanizates, or else between the layers composed of the other rubbers. By way of example, it is therefore possible to apply a very thin layer composed of hydrogenated vinylpolybutadiene by spraying of a solution, or a prefabricated sheet, in order to provide shielding from external environmental effects. Alternatively, the location of the layers can be in the interior of structures if they are intended to be an element which has a load-bearing, adherent or other function. The layer thicknesses of the hydrogenated vinylpolybutadienes, and of the other rubbers, can therefore vary widely from about 1 μm to a number of centimetres. The layers here prior to combination can be either unvulcanized or partially vulcanized layers.

It is also possible to produce layered-structure vulcanizates by continuous production of rubber mixtures which comprise hydrogenated vinylpolybutadiene, with mixtures of other rubbers containing double bonds, e.g. by coextrusion using suitable dies, and then to vulcanize the unvulcanized layer structure.

The following are in particular mentioned as rubbers which contain double bonds and which can be used for the structure of the layers for the vulcanizates of the invention: polyisoprene of synthetic or natural origin (IR and NR), styrene-butadiene rubber (SBR), butadiene rubbers (BR), acrylonitrile-butadiene rubbers (NBR), butyl rubbers (IIR), bromobutyl rubbers (BIIR), chlorobutyl rubbers (CIIR), polychloroprene rubbers, hydrogenated acrylonitrile-butadiene rubbers (HNBR), epoxidized natural rubber (ENR), polynorbornene rubbers, and rubbers based on ethylene-propylene polymers (EPDM), preference being given to SBR rubber, BR rubber and NR rubber. It is, of course, possible to use the individual rubbers in a mixture with one another if the subsequent use of the layered-structure vulcanizates of the invention requires this. At least one layer of the rubbers of the invention comprises rubbers containing double bonds. They are preferably composed of SBR rubber, polybutadiene rubber or natural rubber or a mixture thereof.

The hydrogenated vinylpolybutadienes that are used for the layered structure of the vulcanizates of the invention can be produced according to the teaching of DE 103 24 304 A1. For the production of the layered-structure vulcanizates, other mixing constituents can also be admixed with the hydrogenated vinylpolybutadienes, as also can a sulphur-containing vulcanization system, for subsequent vulcanization.

Usual mixing constituents for the hydrogenated vinylpolybutadienes are fillers, filler activators, plasticizers, antioxidants and mould-release agents, and the known constituents required for sulphur vulcanization. It is also possible to add known reinforcing materials.

Fillers that can be used are inter alia carbon black, silica, calcium carbonate, barium sulphate, zinc oxide, magnesium oxide, aluminium oxide, iron oxide, diatomaceous earth, cork flour and/or silicates. The selection of the fillers depends on the property profile to be achieved in the vulcanizates. If, for example, flame-retardant modification of the vulcanizates is intended, it is advisable to use appropriate hydroxides, such as aluminium hydroxide, magnesium hydroxide, or calcium hydroxide, or to use hydrous salts, in particular salts which comprise water in the form of water of crystallization.

The amounts generally used of the fillers are from about 0.1 to 150 phr. It is, of course, also possible to use a very wide variety of fillers in a mixture with one another.

Filler activators can also be added together with the fillers, in order to achieve certain product and/or vulcanization properties. The filler activators can be added during production of the mixture, but it is also possible to treat the filler with filler activator before it is added to the rubber mixture. Organic silanes can be used for this purpose, examples being bis(triethoxysilylpropyl)polysulphane, vinyltrimethoxysilane, vinyldimethoxymethylsilane, vinyltriethoxysilane, vinyltris(2-methoxyethoxy)silane, N-cyclohexyl-3-aminopropyltrimethoxy-silane, 3-aminopropyltrimethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyltrimethoxysi lane, and (octadecyl)methyldimethoxysilane. Examples of further filler activators are surfactant substances, such as triethanolamine and ethylene glycols whose molar masses are from 74 to 10 000 g/mol. The amount of the activators is usually from about 0.1 to 5 phr, based on the amount of rubber content.

Plasticizers or process oils used preferably comprise high-boiling petroleum fractions or else synthetic plasticizers, which can comprise different quantitative proportions of aliphatic, naphthenic and aromatic hydrocarbons. An overview of the plasticizers or process oils that are to be used is given in: Ullmann's Encyklopädie der technischen Chemie [Ullmann's encyclopaedia of industrial chemistry], 4th Edn., Volume 24, pp. 349-380 (1977). The amounts used of these plasticizers are from about 0.1 to about 100 phr.

The sulphur vulcanizates composed of hydrogenated vinylpolybutadienes can be protected in the usual way from various environmental effects, such as exposure to heat, UV light, ozone or dynamic fatigue, by adding antioxidants.

Particular antioxidants that can be used are: p-phenylenediamines, such as N-isopropyl-N'-phenyl-p-phenylenediamine, N-(1,3-dimethylbutyl)-N′-phenyl-p-phenylenediamine and N,N′-di(1,4-dimethylpentyl)-p-phenylenediamine, secondary aromatic amines, such as oligomerized 2,2,4-trimethyl-1,2-dihydroquinoline (TMQ), styrenated diphenylamine (DDA), octylated diphenylamine (OCD) and phenyl-α-naphthylamine (PAN), mercapto compounds, such as 2-mercaptobenzimidazole, and 4- and 5-methylmercaptobenzimidazole (MB2) or their zinc salts (ZMB2).

Alongside these, it is also possible to use the known phenolic antioxidants, such as sterically hindered phenols. It is also possible to use a combination of antioxidants mentioned.

In addition to the antioxidants mentioned, it is also possible to use the known amount of light-stabilizer wax and of anti-ozonant wax, to improve the resistance of the vulcanizates to exposure to light and/or to ozone. Paraffins having different chain lengths can in particular be used for this purpose.

The amounts usually used of the anti-ozonants are from about 0.1 to 8 phr, preferably from 0.3 to 5 phr, based on the total amount of polymer.

Examples of long-release agents that can be used are: saturated or partially unsaturated fatty and oleic acids and their derivatives (fatty acid esters, fatty acid salts, fatty alcohols, fatty acid amides), and also products that can be applied to the mould surface, e.g. products based on low-molecular-weight silicone compounds, products based on fluoropolymers, and products based on phenolic resins.

The amounts used of the mould-release agents as mixing constituent are from about 0.2 to 10 phr, preferably from 0.5 to 5 phr, based on the total amount of polymer.

The crosslinking of rubbers containing double bonds by means of sulphur and accelerators is known to the person skilled in the art and is described by way of example in general form in W. Hofmann, Vulkanisation & Vulkanisationsmittel, publ. Bayer AG Leverkusen (1965), Th. Kempermann, in: Bayer-Mitteilungen far die Gummi-Industrie [Bayer communications for the rubber industry] 50, 29-38 (1978), 51, 17-33 (1979), 52, 13-23 (1980), L H. Davis, A. B. Sullivan, A. Y. Coran, Rubber Chemistry and Technology 60, 125 (1987), R. Casper, J. Witte and G. Kuth in Ullmann's Encyklopadie der technischen Chemie [Ullmann's encyclopaedia of industrial chemistry], 4th Edn., Volume 13, pp. 640-644 (1977). The treatises mentioned also give relatively detailed descriptions of the suitable crosslinking agents and accelerators for sulphur vulcanization of the hydrogenated vinylpolybutadienes.

Sulphur can be used in soluble or insoluble elemental form for the crosslinking reaction, or else in the form of sulphur donors.

Examples of sulphur donors that can be used are: dimorpholyldisulphide, 2-morpholinodithiobenzothiazole, caprolactam disulphide, dipentamethylenethiuram tetrasulphide or tetramethylthiuram disulphide.

For conduct of sulphur vulcanization it is advisable to add not only the sulphur or sulphur donors but also suitable accelerators, in order to obtain industrially useful vulcanization performance and, respectively, industrially adequate physical properties of the vulcanizates. However, it is also possible in principle to carry out the crosslinking with sulphur or sulphur donors alone. It is also possible to carry out the crosslinking of the hydrogenated vinylpolybutadienes using a number of accelerators or accelerator combinations alone, without any addition of elemental sulphur or sulphur donors, if this gives a useful property profile.

Additionally accelerators and crosslinking agents used for the accelerated sulphur crosslinking of hydrogenated vinylpolybutadienes are those based on dithiocarbamates, on thiurams, on thiazoles, on sulphenamides, on xanthogenates, on guanidine accelerators, on dithiophosphates and on caprolactams.

Examples of dithiocarbamates that can be used are: zinc dimethyldithiocarbamate, zinc diethyldithiocarbamate, zinc dibutyldithiocarbamate, zinc ethylphenyldithiocarbamate, zinc dibenzyldithiocarbamate, zinc pentamethylenedithiocarbamate, tellurium diethyldithiocarbamate, nickel dibutyldithiocarbamate, nickel dimethyldithiocarbamate or zinc diisononyldithiocarbamate.

Examples of thiurams used are tetramethylthiuram disulphide, tetramethylthiuram monosulphide, dimethyldiphenylthiuram disulphide, tetrabenzylthiuram disulphide, dipentamethylenethiuram tetrasulphide or tetraethylthiuram disulphide. Examples of thiazoles used are: 2-mercaptobenzothiazole, dibenzothiazyl disulphide, zinc mercaptobenzothiazole, benzothiazyldicyclohexylsulphenamide, N-tert-butyl-2-benzothiazolsulphenimide or copper 2-mercaptobenzothiazole. Examples of sulphenamide accelerators used are: N-cyclohexylbenzothiazylsulphenamide, N-tert-butyl-2-benzothiazylsulphenamide, benzothiazyl-2-sulphenic morpholide, N-dicyclohexyl-2-benzothiazylsulphenamide, 2-morpholinobenzothiazylsulphenamide, 2-morpholinodithiobenzothiazole, N-oxydiethylenethiocarbamyl-N-tert-butylsulphenamide or oxydiethylenethiocarbamyl-N-oxydiethylenesulphenamide. Examples of xanthogenate accelerators used are: sodium dibutyl xanthogenate, zinc isopropyl dibutyl xanthogenate or zinc dibutyl xanthogenate. Examples of guanidine accelerators used are: diphenylguanidine, di-o-tolylguanidine, o-tolylbiguanide. Examples of dithiophosphates that are used are: zinc dialkyldithiophosphates (chain length alkyl radicals C₂ to C₁₆), copper dialkyl dithiophosphates (chain length alkyl radicals C₂ to C₁₆) or dithiophoshoryl polysulphide. An example of a caprolactam used is dithiobiscaprolactam. Examples of further accelerators that can be used are: zinc diaminediisocyanate, hexamethylenetetramine, 1,3-bis(citraconimidomethyl)benzene, and cyclic disulphanes.

The above accelerators and crosslinking agents can be used either individually or else in a mixture. The following substances are preferably used for the crosslinking of the hydrogenated vinylpolybutadienes: sulphur, 2-mercaptobenzothiazole, tetramethylthiuram disulphide, tetramethylthiuram monosulphide, zinc dibenzyldithiocarbamate, dipentamethylenethiuram tetrasulphide, zinc dialkydithiophosphates, dimorpholyl disulphide, tellurium diethyldithiocarbamate, nickel dibutyldithiocarbamate, zinc dibutyldithiocarbamate, zinc dimethyldithiocarbamate, dithiobiscaprolactam and/or N-cyclohexylbenzothiazylsulphenamide.

The amounts that can be used of the crosslinking agents and accelerators are from about 0.05 to 10 phr, preferably from 0.1 to 8 phr, in particular from 0.5 to 5 phr (individual addition, based in each case on the active substance).

The sulphur crosslinking of the hydrogenated vinylpolybutadienes almost always requires, in addition to the vulcanization accelerators or crosslinking agents, concomitant use of inorganic or organic activators, such as: zinc oxide, zinc carbonate, lead oxide, magnesium oxide, saturated or unsaturated organic fatty acids and their zinc salts, polyalcohols, amino alcohols, e.g. triethanolamine, and amines, such as dibutylamine, dicyclohexylamine, cyclohexylethylamine or polyetheramines.

The vulcanization behaviour in the inventive sulphur crosslinking of the hydrogenated vinylpolybutadienes can also—where technically necessary or desirable—be influenced via suitable retarders. Examples of substance used for this are: N-(cyclohexylthio)phthalimide, phthalic anhydride, N-phenyl-N-(trichloromethylsulphenyl)benzylsulphenamide, benzoic acid and salicylic acid.

Amounts that can be used of activators and retarders are from about 0.1 to 12 phr, preferably from 0.2 to 8 phr, particularly preferably from 0.5 to 5 phr.

It is, of course, also possible to add still further conventional additives and auxiliaries to the rubber mixtures, if this is required for adjustment of the property profile of the hydrogenated vinylpolybutadienes crosslinked according to the invention.

The vulcanizates can moreover be reinforced by addition of reinforcing materials, such as glass fibres, fibres composed of aliphatic and aromatic polyamides, e.g. Aramid®, polyester fibres, polyvinyl alcohol fibres, cellulose fibres, natural fibres, such as cotton or wood fibres, or textiles composed of cotton, polyester, polyamide, glass cord and steel cord. These reinforcing materials or short fibres must, if appropriate, be modified for adhesion prior to their use (e.g. by RFL dip) in order to permit secure bonding to the elastomer. It is also possible to use the inventive co-vulcanizates to produce composite articles with steel, with thermoplastics and with thermosets. The composite is produced either during the vulcanization process, if appropriate with the use of suitable coupling agent systems or after prior activation (e.g. etching, plasma activation) of the substrate or else via adhesive bonding after vulcanization.

The hydrogenated vinylpolybutadienes to be used according to the invention are mixed with the abovementioned additives prior to the vulcanization process in the usual assemblies, such as internal mixers or extruders, or on rolls. The mixing of the other rubbers mentioned intended for use in the composite with the hydrogenated vinylpolybutadienes takes place according to the prior art in an identical or similar manner.

The mixture can be processed in a known manner, for example by calendering, transfer moulding, extrusion or injection moulding. The processing temperature is to be selected in such a way as to prevent premature vulcanization. Appropriate preliminary experiments can be carried out to achieve this.

The ideal temperature for carrying out the vulcanization of the composition product naturally depends on the reactivity of the crosslinking system used, and in the present case can be from room temperature (about 20° C.) to about 220° C., preferably at elevated pressure, since this mostly proves advantageous for achievement of adhesion. The crosslinking times are generally from 20 seconds to 60 minutes, preferably from 30 seconds to 30 minutes.

The vulcanization reaction itself can be carried out conventionally, in vulcanization presses or in autoclaves, or in the presence of hot air, microwaves or other high-energy radiation (e.g. UV radiation or IR radiation), or else in a salt bath.

In order to achieve certain product properties or in order to complete the vulcanization process, subsequent heat-conditioning can be necessary. In these cases, the temperatures used for subsequent heat-conditioning are in the range from 60° C. to 220° C. for a period of from about 2 minutes to 24 h, if appropriate at reduced pressure.

The layered-structure vulcanizates of the invention can be used for the production of any rubber moulding, particular examples being technical rubber items and tyre components which have layer structure. Examples which may be mentioned of rubber mouldings which have a layer structure are: tyres, tyre components, tyre side walls, drive belts, inflatable boats, conveyor belts, profiles, hoses, sheets, coverings, coatings, soles, gaskets, cable sheathing, bellows, pouffes, and composite products composed of rubber/metal, rubber/plastic and rubber/textile, preferably tyres, drive belts, conveyor belts, profiles, hoses, and composite products composed of rubber/metal, rubber/plastic and rubber/textile.

### EXAMPLES

### 1. Production of Rubber Mixtures

Production of the rubber mixtures in Table 1 used an internal mixer of capacity 1.5 l with “intermeshing rotor geometry” (GK1.5E from Werner & Pfleiderer). The internal mixer was pre-heated to a temperature of 50° C. First, the rubbers were in each case added to the mixer. After 30 s, all of the other components other than the sulphur and the accelerators were added and mixed at a constant rotor rotation rate of 50 rpm. After 4 min of mixing time, the mixtures were discharged and cooled in air to room temperature. The sulphur and the accelerators were then incorporated by mixing on the roll at 40° C.

4 rubber mixtures of the following composition were produced to demonstrate the effect of the invention.

TABLE 1
Composition of rubber mixtures

| | [pts. | | Mixture | Mixture | Mixture |
|---|---|---|---|---|---|
| Constituents | by wt.] | Mixture 1 | 2 | 3 | 4 |
| NR¹⁾ | [phr] | 50 | — | 60 | 60 |
| E-SBR Krynol 1712²⁾ | [phr] | 68.75 | — | — | — |
| HVIBR 85³⁾ | [phr] | — | 100 | — | — |
| BR (CB 25)⁴⁾ | [phr] | — | — | 40 | — |
| Buna EP G 6950⁵⁾ | [phr] | — | — | — | 40 |
| N 660⁶⁾ | [phr] | 43 | | | |
| N 326⁶⁾ | [phr] | | 60 | 60 | 60 |
| Enerthene 1849-1⁷⁾ | [phr] | 8 | 5 | 5 | 5 |
| Edenor C 1898-100⁸⁾ | [phr] | 1.5 | 2.5 | 2.5 | 2.5 |
| Antilux 111⁹⁾ | [phr] | — | 1.0 | 1.0 | 1.0 |
| 6PPD¹⁰⁾ | [phr] | — | 2.5 | 2.5 | 2.5 |
| TMQ¹¹⁾ | [phr] | 1.5 | 1.5 | 1.5 | 1.5 |
| Zinc oxide¹²⁾ | [phr] | 4.0 | 5.0 | 5.0 | 5.0 |
| CBS¹³⁾ | [phr] | | 1.0 | 0.7 | 0.7 |
| MBT¹⁴⁾ | [phr] | 0.5 | — | — | — |
| TMTM¹⁵⁾ | [phr] | 1.25 | — | — | — |
| Sulphur¹⁶⁾ | [phr] | 2.0 | 2.5 | 2.5 | 2.5 |

¹⁾Technically Specified Natural Rubber Grade 5 (NR TSR5), pre-masticated to DEFO 700 on a laboratory roll system.
²⁾Butadiene-styrene rubber (Krynol 1712 from Lanxess Elastomer France) with 23.5% by weight of incorporated styrene, extended with 27.3 phr of oil, Mooney viscosity ML 1 + 4/100° C. = 51 MU
³⁾Hydrogenated vinylpolybutadiene produced to DE 10324304 A1; product name: HVIBR 85 (vinyl content prior to hydrogenation: 50%, degree of hydrogenation: 85%; Mooney viscosity ML 1 + 4/125° C. = 78 MU)
⁴⁾High-cis polybutadiene based on neodymium catalyst (Buna CB 25 from Lanxess Deutschl and GmbH) with cis-content of at least 96%, Mooney viscosity ML 1 + 4/100° C. = 44 MU
⁵⁾Buna EP G 9650 from Lanxess Deutschland GmbH (ethene content: 53% by weight; ENB content: 6.5% by weight; Mooney viscosity (ML 1 + 8/150° C. = 60 MU)
⁶⁾Carbon blacks from Degussa AG
⁷⁾Mineral oil from BP Deutschland GmbH
⁸⁾Stearic acid from Cognis Deutschland GmbH
⁹⁾Light-stabilizer wax based on a paraffin mixture with melting range from 64-68° C., from RheinChemie Rheinau GmbH
¹⁰⁾N-1,3-Dimethylbutyl-N′-phenyl-p-phenylenediamine (Vulkanox ® 4020/LG from Lanxess Deutschland GmbH)
¹¹⁾2,2,4-Trimethyl-1,2-dihydroquinolene/polymers (Vulkanox ® HS from Lanxess Deutschland GmbH)
¹²⁾Rotsiegel zinc white from Grillo Zinkoxid GmbH
¹³⁾N-Cyclohexyl-2-benzothiazylsulphenamide (Vulkacit ® CZ/EG from Lanxess Deutschland GmbH)
¹⁴⁾2-Mercaptobenzothiazole (Vulkacit ® Merkapto from Lanxess Deutschland GmbH)
¹⁵⁾Tetramethylthiuram monosulphide (Rhenogran ® TMTM 80 from RheinChemie Rheinau GmbH)
¹⁶⁾Chancel 90/95° ground sulphur from Solvay Deutschland GmbH

### 2. Determination of Tack on Unvulcanized Mixtures

To determine tack, sheet pre-forms of thickness from 1.2 to 1.5 mm composed of the unvulcanized mixtures were taken from the laboratory roll system. Both sides of the pre-forms were covered with Teflon film, and flat sheets of thickness 1 mm were produced from the pre-forms by pressing in a cold laboratory press (press time 30 min at 150 bar). Test specimens of dimensions 48*6*1 mm were stamped out of these sheets.

Prior to the test, the film was removed, and the specimens were pressed against one another in the shape of a cross at an angle of 90° (contact time 10 s with pressure force of 6.67N). The geometry of the specimen gives a contact area of 36 mm².

The specimens are then pulled apart in a Tel Tack device from Monsanto, the rate of advance used being 1 inch/min, and the force needed for this is measured. For each mixing combination, six test specimens were produced and tested.

Tack measurements were carried out on the following layer combinations, giving the following maximum values for separation force (median values from six tests):

Mixture 1/mixture 2: 4 N (example of the invention)
Mixture 1/mixture 3: 3.3 N (comparative example)
Mixture 1/mixture 4: 5 N (comparative example)

These experiments showed that the tack of the unvulcanized mixture of the invention, based on hydrogenated vinylpolybutadiene, is at the level of the comparative mixtures, without addition of foreign rubbers.

### 3. Determination of Adhesion after Vulcanization

The vulcanization of the mixtures was determined to ASTM D 5289 at 180° C. with a test time of 30 minutes using the MDR2000 moving die rheometer from Alpha Technology. Characteristic vulcameter values are: Fₐ, Fₘₐₓ, Fₘₐₓ−Fₐ, t₁₀, t₅₀, t₉₀ and t₉₅

TABLE 2
Vulcanization behaviour of rubber mixtures

| | | Rubber mixture No.: | | | |
|---|---|---|---|---|---|
| | | Mixture 1 | Mixture 2 | Mixture 3 | Mixture 4 |
| Fₐ | [dNm] | 0.40 | 2.56 | 2.72 | 2.72 |
| Fₘₐₓ | [dNm] | 9.89 | 22.35 | 20.08 | 19.82 |
| Fₘₐₓ − Fₐ | [dNm] | 9.49 | 19.78 | 17.36 | 17.10 |
| t₁₀ | [min] | 0.82 | 3.1 | 2.17 | 1.91 |
| t₅₀ | [min] | 1.01 | 5.48 | 3.08 | 3.31 |
| t₉₀ | [min] | 1.53 | 14.42 | 5.54 | 6.81 |
| t₉₅ | [min] | 1.93 | 19.02 | 6.51 | 7.96 |

### Key to DIN 53 529, Part 3:

Fₐ: vulcameter value indicated a minimum of crosslinking isotherm
Fₘₐₓ: maximum vulcameter value indicated
Fₘₐₓ−Fₐ: difference between maximum and minimum of vulcameter values indicated
t₁₀: juncture at which 10% of final conversion has been achieved
t₅₀: juncture at which 50% of final conversion has been achieved
t₉₀: juncture at which 90% of final conversion has been achieved
t₉₅: juncture at which 95% of final conversion has been achieved

To determine adhesion after vulcanization, sheet pre-forms of thickness of 2 mm composed of the unvulcanized mixtures were taken from the laboratory roll system. Strips of dimensions 150×20×2 mm were stamped out of these sheets. The strips of mixture of the different mixture combinations were mutually superposed with exact registration, and Teflon film was inserted on an area of 60 mm² in the upper portion so that the grips of the tensile testing machine could subsequently be attached there. The test specimens thus prepared were vulcanized at a temperature of 160° C. and at a pressure of 150 bar in suitable moulds; vulcanization time: 15 min. Prior to the start of the test, the vulcanized composite products were placed into intermediate storage at room temperature for 24 h.

To carry out the separation test, the non-adhering ends of the composite products were clamped into the grips of the traversing element of the tensile testing machine and pulled apart, the advance rate used being 100 mm/min.

The following values for the adhesion of the layers after vulcanization were determined here (median values from six tests):

Mixture 1/mixture 2: 120 N (example of the invention)
Mixture 1/mixture 3: 125 N (comparative example)
Mixture 1/mixture 4: 140 N (comparative example)

The example of the invention showed that the bond strength of the layer composed of hydrogenated vinylpolybutadiene after vulcanization is of the same order of magnitude as in the comparative examples. In contrast to the comparative examples, no foreign rubber was added to the layer of the invention composed of hydrogenated vinylpolybutadiene.

1. Layered-structure vulcanizates, characterized in that at least one of the layers comprises hydrogenated vinylpolybutadiene rubber whose vinyl content prior to hydrogenation is from 30 to 70% and whose degree of hydrogenation is from 70 to 98%, and whose Mooney values are from 40 to 140 Mooney units (ML 1+4/125° C.), and the other layers comprise rubbers containing double bonds.

2. Layered-structure vulcanizates according to claim 1, characterized in that at least one other layer comprises rubbers containing double bonds.

3. Layered-structure vulcanizates according to claim 1 or 2, characterized in that at least one other layer comprises SBR rubber, polybutadiene rubber or natural rubber (NR rubber) or a mixture of these rubbers.

4. Process for the production of the vulcanizates according to claim 1, characterized in that the layer structure on which the vulcanizates are based is vulcanized by sulphur vulcanization.

5. Process for the production of the vulcanizates according to claim 1, characterized in that the layer structure on which the vulcanizates are based is produced by combining unvulcanized or partially vulcanized sheet pre-forms, and subsequent sulphur vulcanization.

6. Process for the production of the vulcanizates according to claim 1, characterized in that the layer structure on which the vulcanizates are based is produced by coextrusion and subsequent sulphur vulcanization.

7. Process for the production of the vulcanizates according to claim 1, characterized in that the layer structure on which the vulcanizates are based is produced by application of a solution comprising the hydrogenated vinylpolybutadienes to another layer which comprises the rubbers containing double bonds, and subsequent sulphur vulcanization.

8. Use of the layered-structure vulcanizates according to claim 1 for the production of layered-structure rubber mouldings.

9. Use of the layered-structure vulcanizates according to claim 1 for the production of layered-structure technical rubber items.

10. Use of the hydrogenated vinylpolybutadienes for the production of layered-structure tyre components according to claim 1.

11. Use of the hydrogenated vinylpolybutadienes for the production of layered-structure tyre side walls according to claim 1.
